(19) United States
(12) Patent Application Publication
(10) Pub. No.: US 2015/0235744 A1
(43) Pub. Date: Aug. 20, 2015

(54) PPTC OVER-CURRENT PROTECTION DEVICE

(71) Applicant: FUZETEC TECHNOLOGY CO., LTD., New Taipei City (TW)

(72) Inventors: Jack Jih-Sang CHEN, New Taipei City (TW); Chang-Hung JIANG, New Taipei City (TW)

(73) Assignee: FUZETEC TECHNOLOGY CO., LTD., New Taipei City (TW)

(21) Appl. No.: 14/185,257

(22) Filed: Feb. 20, 2014

(51) Int. Cl. H01C 7/02; H02H 3/08

(52) U.S. Cl. CPC H01C 7/021; H02H 3/085

(57) ABSTRACT

A PPTC over-current protection device includes: a first PPTC component that has a first metal foil layer and a first PTC element including a first polymer matrix, the first metal foil layer being bonded to the first polymer matrix; and a second PPTC component that has a second metal foil layer and a second PTC element including a second polymer matrix. The second metal foil layer is bonded to the second polymer matrix. The first and second PPTC components are stacked one above the other and are bonded to each other to form a stack with the first and second metal foil layers being bonded to each other or with the first and second polymer matrices being bonded to each other.

### BACKGROUND OF THE INVENTION

1. Field of the Invention

This invention relates to a polymer positive temperature coefficient (PPTC) over-current protection device, more particularly to a PPTC over-current protection device including first and second PPTC components stacked and bonded together.

2. Description of the Related Art

A polymer positive temperature coefficient (PPTC) device exhibits a PTC effect that renders the same to be useful as an over-current protection device, such as a resettable fuse. As shown in FIG. 1, a conventional PPTC over-current protection device normally includes a PPTC element 61 sandwiched between two metal foil layers 62, 63, and two conductive leads 64, 65 attached to the metal foil layers 62, 63, respectively. The PPTC element 61 is made from a composition and including a polymer matrix and a carbon black powder dispersed in the polymer matrix.

The composition of the PPTC element 61 is formulated based on a desired trip current and a desired resistance which depend on each other. When a trip current is applied to the PPTC element 61 under a fixed voltage to cause the temperature of the PPTC element 61 to increase to a trip temperature, the resistance of the PPTC element 61 will increase rapidly and sharply at the trip temperature, causing the current passing through the PPTC element 61 to become almost zero and resulting in a power-off state. The duration from the beginning of application of the trip current to the PPTC element 61 to a trip point where the current becomes substantially zero is referred to as trip time. The higher the trip current, the shorter will be the trip time.

Since the trip time and the resistance of the PPTC element 61 depend on each other, formulation of the composition of the PPTC element 61 for a desired new specification of the PPTC element 61 is usually conducted in a trial and error manner and requires many experiments. For instance, when a specification is required to be changed from a trip current of 1 A and a resistance of 1Ω to a trip current of 1 A and a resistance of 2Ω, a conventional way of achieving the new specification is usually conducted by reducing the amount of the carbon black powder in the composition. Although reduction of the concentration of the carbon black powder in the composition can increase the resistance of the composition from 1Ω to 2Ω, the trip current or the trip time of the composition is also changed correspondingly. Hence, meeting the new specification cannot be achieved merely by adjusting the amount of the carbon black powder in the composition, and often requires adjustment of the concentrations of other components of the composition and/or addition of other materials into the composition.

### SUMMARY OF THE INVENTION

Therefore, an object of the present invention is to provide a PPTC over-current protection device that can overcome the aforesaid drawback associated with the prior art.

According to one aspect of this invention, there is provided a PPTC over-current protection device that comprises: a first PPTC component that has a first metal foil layer and a first PTC element, the first PTC element including a first polymer matrix and a first conductive filler dispersed in the first polymer matrix, the first metal foil layer being bonded to the first polymer matrix; and a second PPTC component that has a second metal foil layer and a second PTC element. The second PTC element includes a second polymer matrix and a second conductive filler dispersed in the second polymer matrix. The second metal foil layer of the second PPTC component is bonded to the second polymer matrix. The first and second PPTC components are stacked one above the other, and are bonded to each other to form a stack with the first and second metal foil layers being bonded to each other or with the first and second polymer matrices being bonded to each other.

According to another aspect of this invention, there is provided a PPTC over-current protection device that comprises : a first PPTC component that has two first metal foil layers and a first PTC element sandwiched between the first metal foil layers, the first PTC element including a first polymer matrix and a first conductive filler dispersed in the first polymer matrix, the first metal foil layers being bonded to the first polymer matrix; a second PPTC component that has two second metal foil layers and a second PTC element sandwiched between the second metal foil layers, the second PTC element including a second polymer matrix and a second conductive filler dispersed in the second polymer matrix; and a third PPTC component that has two third metal foil layers and a third PTC element sandwiched between the third metal foil layers. The third PTC element includes a third polymer matrix and a third conductive filler dispersed in the third polymer matrix. The third metal foil layers are bonded to the third polymer matrix. The first, second and third PPTC components are stacked one above another to form a stack, such that one of the first metal foil layers is bonded to one of the second metal foil layers and that one of the third metal foil layers is bonded to the other of the second metal foil layers.

### BRIEF DESCRIPTION OF THE DRAWINGS

In drawings which illustrate embodiments of the invention,

FIG. 1 is a perspective view of a conventional PPTC over-current protection device;

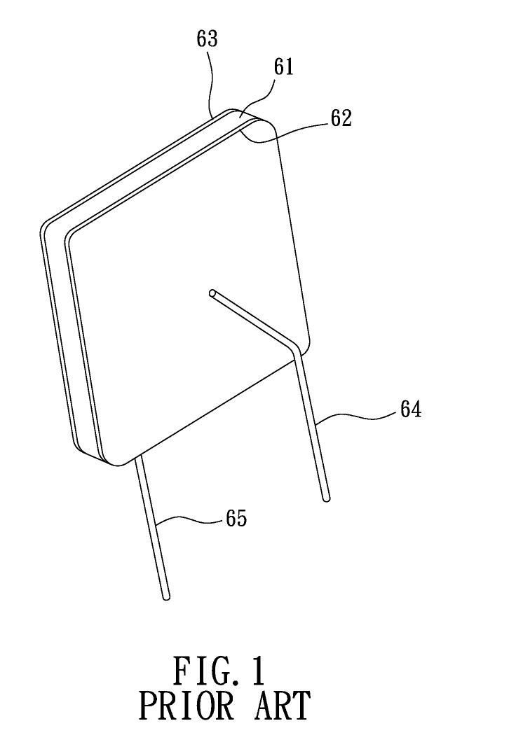

FIG. 2 is a perspective view of the first preferred embodiment of a PPTC over-current protection device according to the present invention;

FIG. 3 is a perspective view of the second preferred embodiment of a PPTC over-current protection device according to the present invention; and

FIG. 4 is a perspective view of the third preferred embodiment of a PPTC over-current protection device according to the present invention.

### DETAILED DESCRIPTION OF THE PREFERRED EMBODIMENTS

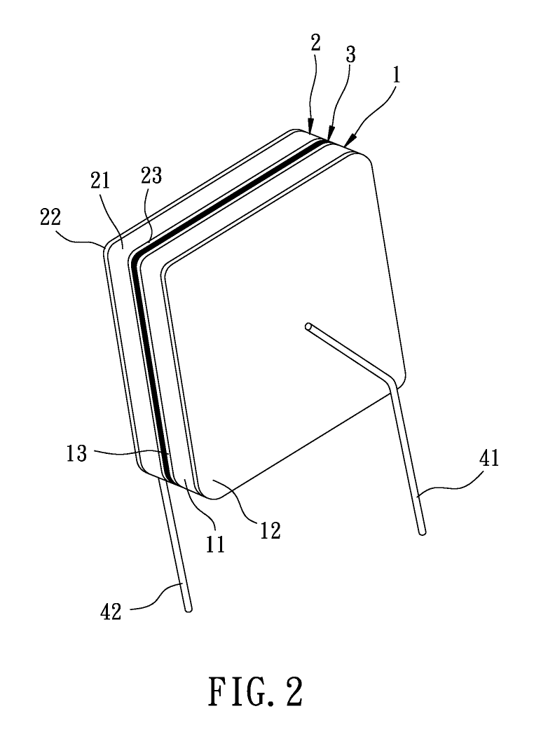

FIG. 2 illustrates the first preferred embodiment of a PPTC over-current protection device according to the present invention. The PPTC over-current protection device includes first and second PPTC components 1, 2, first and second conductive leads 41, 42, and a solder material 3. The first PPTC component 1 has two first metal foil layers 12, 13 and a first PTC element 11 sandwiched between the first metal foil layers 12, 13. The first PTC element 11 is made from a first composition, and includes a first polymer matrix and a first conductive filler dispersed in the first polymer matrix. The first metal foil layers 12, 13 are bonded to the first polymer matrix.

The second PPTC component 2 has two second metal foil layers 22, 23 and a second PTC element 21 sandwiched between the second metal foil layers 22, 23. The second PTC element 21 is made from a second composition, and includes a second polymer matrix and a second conductive filler dispersed in the second polymer matrix. The second metal foil layers 22, 23 of the second PPTC component 2 are bonded to the second polymer matrix.

The first and second PPTC components 1, 2 are stacked one above the other and are bonded to each other to form a stack with one of the first metal foil layers 13 and one of the second metal foil layers 23 being bonded to each other through the solder material 3.

The first and second conductive leads 41, 42 are soldered to two opposite end faces of the stack, that are defined by the other of the first metal foil layers 12 of the first PPTC component 1 and the other of the second metal foil layers 22 of the second PPTC component 2, using a solder material (not shown), respectively.

Preferably, each of the first and second polymer matrices is made from high density polyethylene.

Preferably, each of the first and second polymer matrices is made from a polyolefin blend including non-grafted HDPE and carboxylic acid anhydride grafted HDPE.

Preferably, the polyolefin blend of each of the first and second polymer matrices is in an amount ranging from 40to 55 wt % based on the weight of the respective one of the first and second polymer compositions, and each of the first and second conductive fillers is in an amount ranging from 45 to 60 wt % based on the weight of the respective one of the first and second polymer compositions.

Preferably, each of the first and second conductive fillers is made from carbon black.

Preferably, the first and second compositions are the same.

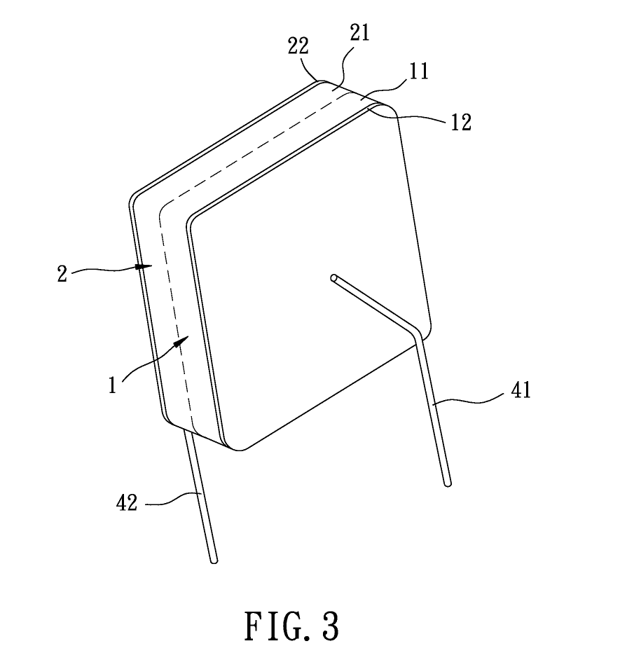

FIG. 3 illustrates the second preferred embodiment of a PPTC over-current protection device according to the present invention.

The PPTC over-current protection device includes first and second PPTC components 1, 2. The first PPTC component 1 has a first metal foil layer 12 and a first PTC element 11 bonded to the first metal foil 12. The second PPTC component 2 has a second metal foil layer 22 and a second PTC element 21 bonded to the second metal foil layer 21. The first and second PTC elements 11, 21 of the second preferred embodiment are made from compositions similar to those of the first and second PTC elements 11, 21 of the first preferred embodiment, respectively.

The first and second PPTC components 1, 2 of the second preferred embodiment are stacked one above the other and are bonded to each other to form a stack with the first and second polymer matrices being bonded to each other. The first and second conductive leads 41, 42 are soldered to two opposite end faces of the stack, that are defined by the first metal foil layer 12 and the second metal foil layer 22, using a solder material (not shown), respectively.

Preferably, the first and second polymer matrices are bonded to each other by interfusion-bonding using thermal lamination techniques.

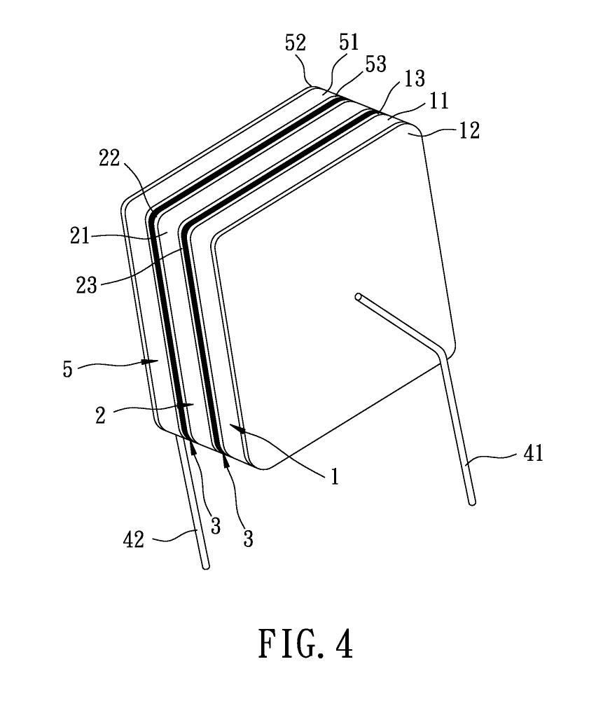

FIG. 4 illustrates the third preferred embodiment of a PPTC over-current protection device according to the present invention.

The PPTC over-current protection device includes first, second and third PPTC components 1, 2 and 5. The first and second PPTC components 1, 2 of the third preferred embodiment have structures similar to those of the first and second PPTC components 1, 2 of the first preferred embodiment, respectively. The third PPTC component 5 has two third metal foil layers 52, 53 and a third PTC element 51 sandwiched between the third metal foil layers 52, 53. The third PTC element 51 is made from a third composition, and includes a third polymer matrix and a third conductive filler dispersed in the third polymer matrix. The third metal foil layers 52, 53 are bonded to the third polymer matrix.

The first, second and third PPTC components 1, 2, and 5 are stacked one above another to form a stack, such that one of the first metal foil layers 13 is bonded to one of the second metal foil layers 23 through the solder material 3, and that one of the third metal foil layers 53 is bonded to the other of the second metal foil layers 22 through the solder material 3.

The following examples and comparative examples are provided to illustrate the preferred embodiments of the invention, and should not be construed as limiting the scope of the invention.

### EXAMPLES

### Preparation of PPTC Component A

10.5 grams of HDPE (purchased from Formosa Plastics Corporation, catalog no.: HDPE9002, having a weight average molecular weight of 150000 g/mole), 10.5 grams of carboxylic acid anhydride grafted HDPE (purchased from DuPont, catalog no.: MB100D, having a weight average molecular weight of 80000 g/mole), and 29 grams of carbon black powder (purchased from Columbian Chemicals Company, catalog no.: Raven 430UB, having a DBP/D of 0.95 and a bulk density of 0.53 g/cm³) were compounded in a Brabender mixer. The compounding temperature was 200° C., the stirring rate was 30 rpm, and the compounding time was 10 minutes . The compounded mixture was hot pressed in a mold so as to form a thin sheet of the PPTC element A having a thickness of 0.35 mm. The hot pressing temperature was 200° C., the hot pressing time was 4 minutes, and the hot pressing pressure was 80 kg/cm². The composition of the PPTC element A thus formed is shown in Table 1.

In Table 1, G-HDPE represents carboxylic acid anhydride grafted HDPE. Two copper foil sheets were attached to two sides of the thin sheet, and were hot pressed under 200° C. and 80 kg/cm² for 4 minutes to form a sandwiched structure of a PPTC component A. The PPTC component A was cut into a plurality of test samples, each having a size of 7.6 mm×7.6 mm.

### Preparation of PPTC Component A1

The procedures and conditions in preparing the test samples of PPCT component Al were similar to those of PPTC component A, except that only one copper foil sheet was attached to one side of the thin sheet. The composition of the PPTC element Al thus formed is shown in Table 1.

### Preparation of PPTC Component B and PPTC Component C

The procedures and conditions in preparing the test samples of PPTC components B and C were similar to those of PPTC component A, except for the amounts of the polymer matrix and the conductive filler. The compositions of the PPTC element B and PPTC element C thus formed are shown in Table 1.

TABLE 1

| PPTC | Polymer matrix | | | | Con- | |
|---|---|---|---|---|---|---|
| com- | | amount | | amount | ductive | amount |
| ponent | Polymer 1 | (wt %) | Polymer 2 | (wt %) | filler | (Wt %) |
| A | HDPE | 21 | G-HDPE | 21 | Carbon | 58 |
| | | | | | black | |
| A1 | HDPE | 21 | G-HDPE | 21 | Carbon | 58 |
| | | | | | black | |
| B | HDPE | 24 | G-HDPE | 24 | Carbon | 52 |
| | | | | | black | |
| C | HDPE | 26 | G-HDPE | 26 | Carbon | 48 |
| | | | | | black | |

### Example 1

### EX1

Two PPTC components A were irradiated by cobalt-60 sources. Each of the PPTC components A had a total radiation dose of 150 kGy. One of the PPTC components A served as the first PPTC component and the other served as the second PPTC component. One of the copper foil sheets of the first PPTC component A was stacked on and was soldered to one of the copper foil sheets of the second PPTC component A through a solder material, followed by soldering first and second conductive leads to the two opposite end faces of the stack, that are defined by the other of the copper foil sheets of the first PPTC component A and the other of the copper foil sheets of the second PPTC component A, using the solder material, respectively.

The trip times obtained under different applied voltages and different trip currents and the resistance of the PPTC over-current protection device of Example 1 were measured. The test results are shown in Table 2.

### Example 2

### EX2

Two PPTC components A1 were irradiated by cobalt-60 sources. Each of the PPTC components A1 had a total radiation dose of 150 kGy. One of the PPTC components A1 served as the first PPTC component and the other served as the second PPTC component.

The first polymer matrix of the first PPTC component A1 was stacked on and was interfusion-bonded to the second polymer matrix of the second PPTC component A1, followed by soldering first and second conductive leads to the two opposite end faces of the stack, that are defined by the copper foil sheet of the first PPTC component A1 and the copper foil sheet of the second PPTC component A1, using the solder material, respectively.

The trip times obtained under different applied voltages and different trip currents and the resistance of the PPTC over-current protection device of Example 2 were measured. The test results are shown in Table 2.

### Examples 3 to 6

### EX3 to EX6

The procedures and conditions in preparing the PPTC over-current protection device of each of Examples 3 to 6 were similar to those of Example 1, except for the compositions of the first and second PPTC elements of the first and second PPTC components (see Table 2).

The trip time obtained under different applied voltages and different trip currents and the resistance of the PPTC over-current protection devices of each of Examples 3 to 6 were measured. The test results are shown in Table 2.

### Example 7

### EX7

Three PPTC components B were irradiated by cobalt-60 sources. Each of the PPTC components B had a total radiation dose of 150 kGy. The three PPTC components B served as the first, second and third PPTC components, respectively.

One of the copper foil sheets of the first PPTC component was stacked on and was soldered to one of the copper foil sheets of the second PPTC component through a solder material, and one of the copper foil sheets of the third PPTC component was stacked on and was soldered to the other of the copper foil sheets of the second PPTC component through the solder material, followed by soldering first and second conductive leads to two opposite end faces of the stack, that were defined by the other of the copper foil sheets of the first PPTC component and the other of the copper foil sheets of the third PPTC component, using the solder material, respectively.

The trip times obtained under different applied voltages and different trip currents and the resistance of the PPTC over-current protection device of Example 7 were measured. The test results are shown in Table 2.

### Comparative Example 1

### CE1

One PPTC component A was irradiated by a cobalt-60 source with a total radiation dose of 150 kGy. First and second conductive leads were soldered to the copper foil sheets of the PPTC component A using a solder material.

The trip time obtained under different applied voltages and different trip currents and the resistance of the PPTC over-current protection device of Comparative Example 1 were measured. The test results are shown in Table 2.

### Comparative Example 2

### CE2

Two PPTC components A were irradiated by cobalt-60 sources, each PPTC component A having a total radiation dose of 150 kGy. One of the PPTC components A served as the first PPTC component and the other served as the second PPTC component. The first and second PPTC components were electrically connected in series in a conventional manner (i.e., the first and second PPTC components 1, 2 were spaced apart from each other and were electrically connected through a conductive trace having a length of 5mm). The first and second conductive leads were soldered to the copper foil sheets of the first and second PPTC components using a solder material, respectively.

The trip time obtained under different applied voltages and different trip currents and the resistance of the PPTC over-current protection device of Comparative Example 2 were measured. The results are shown in Table 2.

### Comparative Examples 3 and 4

### CE3 and CE4

The procedures and conditions in preparing the PPTC over-current protection device of each of Comparative Examples 3 and 4 were similar to those of Comparative Example 1, except for the compositions of the PPTC elements of the PPCT components.

The trip time obtained under different applied voltages and different trip currents and the resistance of the PPTC over-current protection device of each of Comparative Examples 3 and 4 were measured. The results are shown in Table 2.

TABLE 2

| | 1st | 2^{nd} | 3^{rd} | | Time to trip (second) | | | |
|---|---|---|---|---|---|---|---|---|
| | PPCT | PPCT | PPCT | Resistance | 16 V/ | 16 V/ | 16 V/ | 16 V/ |
| | component | component | component | (ohm) | 2.5 A | 5.0 A | 10.0 A | 20.0 A |
| E1 | A | A | — | 0.047 | — | 17.2 | 3.4 | 0.7 |
| E2 | A1 | A1 | — | 0.048 | — | 15.7 | 3.1 | 0.6 |
| E3 | B | B | — | 0.119 | 34.9 | 5.2 | 1.1 | |
| E4 | C | C | — | 0.475 | 6.6 | 1.6 | — | — |
| E5 | A | B | — | 0.084 | 37.7 | 7.3 | 1.3 | — |
| E6 | A | C | — | 0.266 | 9.8 | 1.7 | — | — |
| E7 | B | B | B | 0.189 | 22.6 | 4.6 | 1.2 | — |
| CE1 | A | — | — | 0.026 | — | 19.0 | 3.8 | 0.8 |
| CE2 | A | A | — | 0.068 | — | 34.4 | 4.4 | 1.1 |
| CE3 | B | — | — | 0.063 | 39.3 | 5.8 | 1.1 | |
| CE4 | C | — | — | 0.243 | 7.6 | 1.5 | — | — |

“—” means none or not available.

As shown in Table 2, the resistance and the trip time under 16V/5.0A are respectively 0.026 ohm and 19.0 seconds for Comparative Example 1 (with one single PPTC component A), and are 0.068 ohm and 34.4 seconds for Comparative Example 2 (with two PPTC components A connected in series in a conventional manner). These results show that although the resistance was raised two times more by connecting two PPTC components A in series in a conventional manner, the trip time is also closely doubled. As such, the conventional manner of connecting two PPTC components cannot achieve the goal of increasing the resistance correspondingly while maintaining the trip time of one of the two PPTC components that has a smaller or equal trip time.

On the other hand, the trip time and the resistance under 16V/5.0A for Example 1 (with two PPTC components A soldered together) are respectively 19.0 seconds and 0.047 ohm. As compared to Comparative Example 1, these results show that, by connecting two PPTC components A in a manner according to this invention, the PPTC over-current protection device with two PPTC components stacked together can raise the resistance thereof about two times while maintaining the trip time thereof similar to that of the PPTC over-current protection device with only one single PPTC component. Similar results are obtained from Example 2 (with two PPTC components A1, the polymer matrixes being bonded to each other by interfusion-bonding), Example 3 (with two PPTC components B soldered together) and Example 4 (with two PPTC components C soldered together) as compared to Comparative Example 1 (with only one PPTC component A), Comparative Example 3 (with only one PPTC component B) and Comparative Example 4 (with only one PPTC component C), respectively.

Moreover, the trip time and the resistance under 16V/10.0A for Example 7 (with three PPTC components B stacked and soldered together) are respectively 1.2 seconds and 0.189 ohm and are respectively 1.1 seconds and 0.063 ohm for Comparative Example 3. These results show that by connecting three PPTC components B in a manner according to this invention, the PPTC over-current protection device with three PPTC components stacked together can raise the resistance thereof about three times while maintaining the trip time thereof similar to that of the PPTC over-current protection device with only one single PPTC component. Hence, it is demonstrated that by stacking and soldering or interfusion-bonding a plurality of the PPTC components together, the PPTC over-current protection device with multiple PPTC components can raise the resistance thereof correspondingly while maintaining the trip time thereof similar to that of the PPTC over-current protection device with only one single PPTC component.

The advantages of the PPTC over-current protection device of this invention can also be demonstrated from Examples 5 and 6 as shown in Table 2. Example 5 includes the PPTC component A and the PPTC component B that are stacked and soldered together. The trip time of Example 5 under 16V/5.0A is 7.3 seconds which is close to the trip time of Comparative Example 3 (5.8 seconds), and the resistance of Example 5 (0.084 ohm) is about the summation of the resistances of Comparative Example 1 and Comparative Example 3 (0.026+0.063=0.089 ohm). Example 6 includes the PPTC component A and the PPTC component C that are stacked and soldered together. The trip time of Example 6 under 16V/5.0A is 1.7 seconds which is close to the trip time of Comparative Example 4 (1.5 seconds), and the resistance of Example 6 (0.266 ohm) is about the summation of the resistances of Comparative Example 1 and Comparative Example 4 (0.026+0.243=0.269 ohm). It is noted that the trip times of Example 5 and Example 6 are respectively very close to the trip times of Comparative Example 3 and Comparative Example 4 which have trip times much lower than that of Comparative Example 1.

In conclusion, by stacking and bonding the PPTC components together through a solder material or by interfusion-bonding to form the PPTC over-current protection device of the present invention, the resistance of the PPTC over-current protection device can be easily adjusted without significantly altering the trip time of the PPTC over-current protection device.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A polymer positive temperature coefficient (PPTC) over-current protection device comprising:
a first PPTC component that has a first metal foil layer and a first positive temperature coefficient (PTC) element, said first PTC element including a first polymer matrix and a first conductive filler dispersed in said first polymer matrix, said first metal foil layer being bonded to said first polymer matrix; and
a second PPTC component that has a second metal foil layer and a second PTC element, said second PTC element including a second polymer matrix and a second conductive filler dispersed in said second polymer matrix, said second metal foil layer of said second PPTC component being bonded to said second polymer matrix;
wherein said first and second PPTC components are stacked one above the other and are bonded to each other to form a stack with said first and second metal foil layers being bonded to each other or with said first and second polymer matrices being bonded to each other.

2. The PPTC over-current protection device of claim 1, further comprising a solder material, said first and second metal foil layers being bonded to each other through said solder material.

3. The PPTC over-current protection device of claim 1, wherein said first and second polymer matrices are bonded to each other by interfusion-bonding.

4. The PPTC over-current protection device of claim 1, wherein each of said first and second polymer matrixes is made from high density polyethylene.

5. The PPTC over-current protection device of claim 1, wherein each of said first and second conducive fillers is made from carbon black.

6. A polymer positive temperature coefficient (PPTC) over-current protection device comprising:
a first PPTC component that has two first metal foil layers and a first positive temperature coefficient (PTC) element sandwiched between said first metal foil layers, said first PTC element including a first polymer matrix and a first conductive filler dispersed in said first polymer matrix, said first metal foil layers being bonded to said first polymer matrix;
a second PPTC component that has two second metal foil layers and a second PTC element sandwiched between said second metal foil layers, said second PTC element including a second polymer matrix and a second conductive filler dispersed in said second polymer matrix; and
a third PPTC component that has two third metal foil layers and a third PTC element sandwiched between said third metal foil layers, said third PTC element including a third polymer matrix and a third conductive filler dispersed in said third polymer matrix, said third metal foil layers being bonded to said third polymer matrix;
wherein said first, second and third PPTC components are stacked one above another to form a stack, such that one of said first metal foil layers is bonded to one of said second metal foil layers and that one of said third metal foil layers is bonded to the other of said second metal foil layers.

7. The PPTC over-current protection device of claim 6, further comprising a solder material, said one of said first metal foil layers being bonded to said one of said second metal foil layers through said solder material, said one of said third metal foil layers being bonded to said other of said second metal foil layers through said solder material.
